(19) United States
(12) Patent Application Publication
(10) Pub. No.: US 2025/0378324 A1
(43) Pub. Date: Dec. 11, 2025

(54) MEMORY-EFFICIENT INFERENCE COMPUTATION FOR NEURAL NETWORKS ON EMBEDDED SYSTEMS

(71) Applicant: Robert Bosch GmbH, Stuttgart (DE)

(72) Inventors: Cecilia Eugenia De La Parra Aparicio, Herrenberg (DE); Martin Rapp, Esslingen Am Neckar (DE); Nina Bretz, Kornwestheim (DE); Tigran Hovhannisyan, Muenchen (DE); Tobias Kirchner, Ludwigsburg (DE)

(21) Appl. No.: 19/183,528

(22) Filed: Apr. 18, 2025

(30) Foreign Application Priority Data
Apr. 22, 2024 (DE) 10 2024 203 737.0

(51) Int. Cl. G06N 3/08

(52) U.S. Cl. CPC G06N 3/08

(57) ABSTRACT

A method for processing input data by a neural task network, whose behavior is characterized by trainable parameters, to produce output data. The method includes: dividing the processing of the input data by the neural task network to produce output data into multiple calculation steps at least based on the architecture of the neural task network, in which calculation steps different subsets of the trainable parameters are required simultaneously; for each of these calculation steps, ascertaining a retrieval vector for accessing the respective, simultaneously required trainable parameters; feeding the retrieval vector to a hypernetwork, which then outputs the parameters required simultaneously for the calculation step; and carrying out the particular calculation step with these parameters.

### FIELD

The present invention relates to the processing of input data by a predetermined trained neural task network to produce output data, also called inference. The method requires less memory than conventional processing.

### BACKGROUND INFORMATION

Neural networks that have been trained for a specific task are being used in more and more applications in vehicles and other mobile devices. These neural networks are therefore also called task networks. During training, a large number of parameters that characterize the behavior of the task network are set to optimal values. In order to use the task network to process concrete input data to produce output data, all of these parameters are required.

Complex neural networks can contain several million parameters. This requires memory in the range of several tens of MB to several GB. This amount of memory space is often not available in many embedded systems for mobile use. For example, when using systems-on-chip that implement an entire computer on a single integrated circuit (chip), the memory available on the chip is insufficient. External memory must then be used.

### SUMMARY

The present invention provides a method for processing input data by a neural task network. The task network is trained to solve a specific task. Its behavior is characterized by trainable parameters. In particular, these parameters may comprise, for example, weights with which inputs fed to certain neurons are summed into activations of these neurons.

According to an example embodiment of the present invention, in the context of the method, the processing of the input data by the neural task network to produce output data is divided into multiple calculation steps at least based on the architecture of the neural task network, in which calculation steps different subsets of the trainable parameters are required simultaneously. This division can, for example, be based on an organization of the neural network in layers. However, the processing can also be divided into much smaller parts. In particular, the fineness of the division can, for example, be used to set a compromise between memory requirements on the one hand and processing speed on the other.

According to an example embodiment of the present invention, for each of the calculation steps, a retrieval vector for accessing the respective, simultaneously required parameters is ascertained. In particular, this retrieval vector can, for example, specify the position of the respective, simultaneously required trainable parameters in the architecture of the neural network or be another “handle” through which exactly the respective required set of parameters can be accessed. This retrieval vector is fed to a hypernetwork, which then outputs the parameters required simultaneously for the calculation step. The particular calculation step is carried out using these parameters.

This is somewhat analogous to doing DIY activities on a workbench with a limited amount of space that is not enough to accommodate all the materials and tools needed for the entire task. It is possible to remedy this by breaking the overall task down into smaller subtasks and having only the materials and tools that are needed for the current subtask on the work surface. As soon as a subtask is completed, all materials and tools used are put away so that the work surface is returned to its original state except for the actual workpiece on which work progress has just been made. The materials and tools for the next task are then brought out. The finer the division of the entire task, the smaller the work surface can be. On the other hand, it takes time to move items to and from the workbench when changing between work steps. For example, if a particular tool is needed in two consecutive work steps, it is put away at the end of the first work step and taken out again at the beginning of the second work step.

How high-dimensional the retrieval vector must be also depends on the fineness of the division into calculation steps. For example, if the calculation steps correspond to layers of the neural network, a one-dimensional vector that specifies a layer number may be sufficient. However, layers are still comparatively large units in terms of memory requirements. In order to selectively address the parameters relevant to smaller units, retrieval vectors having more components are required.

For example, in a two-dimensional convolutional layer of a convolutional neural network (CNN), each combination of a row r, a column c, an input channel chᵢₙ, and an output channel chₒᵤₜ has its own weight as a parameter. A retrieval vector can, for example, address a single weight as a parameter via these four pieces of information r, c, chᵢₙ, and chₒᵤₜ. However, a retrieval vector can also, for example, refer to only one output channel chₒᵤₜ and address a whole group of weights as parameters. However, the retrieval vector does not necessarily have to specify concrete coordinates via which the parameters can be addressed. Instead, the retrieval vector can be any learned representation of the parameters to which it refers. In a simple example, a set of parameters can be transformed by means of an encoder of a trained encoder-decoder arrangement into a latent representation (also called embedding) with only a few variables. The corresponding decoder can then translate the latent representation back to the original set of parameters.

It was recognized that for the implementation of the trained neural task network on embedded systems, and in particular on systems-on-chip (SoC), lower memory requirements are significantly more important than maximum algorithmic efficiency in the sense that only the absolutely necessary quantum of computational operations is carried out. The overall efficiency decisively depends on whether the calculation can be carried out with the memory provided within the SoC (on-chip memory). If this memory is insufficient and external memory (off-chip memory) has to be used, access to it is orders of magnitude slower than access to on-chip memory. This effect is much stronger than the extension of the running time caused by the fact that, after training the task network, known parameters of this task network are computed by the hypernetwork, possibly several times, instead of being loaded from some kind of memory.

The savings effect in terms of memory consumption is achieved by
a hypernetwork, whose behavior is characterized by a comparatively small number of parameters, being able to predict a significantly larger number of parameters of the task network, and
being able to reuse one and the same hypernetwork with one and the same set of parameters many times to repeatedly ascertain new parameters of the task network in many calculation steps of the task network.

Especially the last-mentioned point results in significant memory savings compared to a solution that, for example, computes all parameters of the task network at once.

Therefore, in a particularly advantageous example embodiment of the present invention, the architecture and size of the hypernetwork are selected such that the behavior of the hypernetwork is characterized by a number of parameters that corresponds at most to a predetermined fraction of the number of parameters that characterize the behavior of the neural task network. The behavior of the hypernetwork can in particular be characterized, for example, by at most 1/500, preferably by at most 1/800, and most preferably by at most 1/1000 as many parameters as the behavior of the task network. Typically, hypernetworks whose behavior is characterized by only a few hundred parameters can thus be used, for example, to predict the several million total parameters of a task network. Such large savings may well be enough to accommodate all required parameters of the hypernetwork in the on-chip memory of an SoC.

The deeper reason why using a hypernetwork can save memory is that there are redundancies in the total set of parameters of the trained task network. This means that the trained task network is over-parameterized so that not all parameters are completely independent of one another. Rather, some parameters are connected to one another via relationships that can be learned by the hypernetwork.

It is also not a problem that the hypernetwork may overfit the training examples used for its training, i.e., may more or less “learn them by heart.” In the context of the method proposed here, the hypernetwork is not expected to be able to generalize to data not seen during training. The only crucial thing is that it can provide as many parameters of the task network as possible while requiring as little memory as possible for the hypernetwork itself and its own parameters.

How many parameters are required simultaneously may depend on the architecture of the neural task network. For example, the architecture can be specifically selected so that it requires a set of parameters simultaneously that match the available memory of the hardware platform to be used.

In particular, the retrieval vectors for each calculation step can be retrieved, for example, from a memory, such as the on-chip memory of an SoC, which also houses the parameters of the hypernetwork. However, the retrieval vectors can also be ascertained, for example, by means of a suitable algorithm from an index of the calculation step.

In a particularly advantageous example embodiment of the present invention, the multiple calculation steps correspond to clock cycles of a hardware platform used for the calculation. During such a clock cycle, a certain amount of data can always be processed at once. If the hypernetwork always provides as many parameters per clock cycle as can actually be used within that clock cycle, the processing capacity of the hardware platform is used optimally. Dividing the calculation into even smaller parts would result in part of the processing capacity remaining unused.

Thus, for one and the same neural task network, the optimal division of the calculation of the output data into multiple calculation steps can depend on the hardware platform used.

In certain neural networks, different processing stages can be characterized by different numbers of parameters. For example, different numbers of filter kernels can be used in different convolutional layers of a convolutional neural network (CNN). The more filter kernels there are, the more parameters characterize the behavior of the convolutional layer. It is comparatively difficult to design a hypernetwork in such a way that it produces outputs of different sizes for different input retrieval vectors. Therefore, in a particularly advantageous embodiment, the architecture of the hypernetwork is selected such that it outputs the same fixed number of parameters for all calculation steps. In this case, it may happen that the reconstruction of the parameters of the task network is no longer exact, but an error is made, for example, due to unreconstructed parameters. However, the impact of such errors is too small to cause a lasting deterioration in the performance of the task network. Finally, conventional efforts to save memory space for parameters of the task network involve significantly more intervention in these parameters, for example, by quantizing them to integer values with a comparatively low resolution or even omitting large numbers of them as part of so-called pruning.

In particular, for example, a fixed number of parameters can be selected that
is less than the largest number of parameters required simultaneously for a calculation step and
is greater than the smallest number of parameters required simultaneously for a calculation step.

In this way, any compromise can be set between the error due to inaccurately reconstructed parameters on the one hand and the memory savings on the other.

In particular, for example, in response to the hypernetwork not having provided all the parameters required simultaneously for a calculation step, the missing required parameters can be set to standard values, such as zero or an average value of the parameters. For example, in response to the hypernetwork having provided more than the parameters required simultaneously for a calculation step, the excess provided parameters can also be discarded (ignored).

In a further particularly advantageous example embodiment of the present invention, the retrieval vector is translated to a higher dimensionality by means of a predetermined coding function and fed in this higher dimensionality to the hypernetwork. Depending on the number of parameters to be output simultaneously by the hypernetwork, a certain minimum dimensionality of the retrieval vector can be required. For example, it is difficult to transform a retrieval vector having only a single component into 1000 output parameters. The coding function allows the retrieval vector to still be stored in low dimensionality but be input in higher dimensionality into the hypernetwork, thus somewhat smoothing the jump to the dimensionality of the desired output. For example, the coding function can contain sine and/or cosine terms that are periodic at different frequencies in the same argument. These sine and/or cosine terms can then be incorporated into various components of the retrieval vector. For example, a single argument z can be transformed into a retrieval vector γ(z) of the form

$$γ ( z ) = ( \begin{matrix}sin ( {2}^{0} π z ) \\ cos ( {2}^{0} π z ) \\ … \\ sin ( {2}^{L - 1} π z ) \\ cos ( {2}^{L - 1} π z )\end{matrix} ) .$$

As explained above, it is particularly advantageous to carry out the calculation on a system-on-chip, SoC, which combines all the functions of a computer in one integrated circuit. In this case, all resources located on the chip can be accessed at significantly lower costs, in terms of both latency and energy consumption, than is the case for resources outside the chip. If the processing by the task network is handled exclusively using on-chip memory, this has an acceleration effect comparable to already having the snack a child urgently wants in the refrigerator at home instead of having to drive 50 km to the nearest city to buy that same snack.

Therefore, it is advantageous to retrieve at least the parameters that characterize the behavior of the hypernetwork from a memory within the SoC. These parameters are among the most frequently required information during the entire processing process. This is in particular the case when one and the same hypernetwork successively ascertains the parameters for multiple calculation steps of the task network.

As explained above, the method according to the present invention can be used profitably, especially in embedded systems for mobile applications. Therefore, in a further, particularly advantageous embodiment, measurement data recorded by means of at least one sensor are selected as input data. A control signal is ascertained from the output data calculated by the task network. A vehicle, a driver assistance system, a robot, a system for quality control, a system for monitoring regions, and/or a system for medical imaging is controlled with the control signal. This ultimately desired control can be achieved by using the method proposed here with significantly less energy expenditure than if a task network were used that stores all trained parameters.

The present invention also provides a method for training a hypernetwork for use in the method proposed above.

In the context of the method of the present invention, a trained neural task network for processing input data to produce output data is provided, the behavior of which trained neural task network is characterized by trainable parameters. The processing of input data by the neural task network to produce output data is divided into multiple calculation steps at least based on the architecture of the neural task network, in which calculation steps different subsets of the trainable parameters are required simultaneously. As explained above, this division can in particular also incorporate, for example, the mode of operation of the hardware platform used and the division of work into clock cycles. If, for example, each calculation step fully utilizes the processing capacity provided in a clock cycle and the hypernetwork provides the necessary parameters, the processing speed achievable with the hardware platform is reduced as little as possible.

According to an example embodiment of the present invention, for each calculation step, a retrieval vector is defined that specifies the position of the respective, simultaneously required trainable parameters in the architecture of the neural network. As explained above, it is sufficient if there is a mapping between the retrieval vector on the one hand and the position of the parameters on the other. This mapping does not have to be particularly “human-readable.” It should just follow a certain logic to make it easier for the hypernetwork to learn. The retrieval vector can be generated, for example, by means of a coding function described above.

According to an example embodiment of the present invention, the retrieval vector is fed to the hypernetwork to be trained, which then outputs the parameters required simultaneously for the calculation step. The deviation of the parameters provided by the hypernetwork from the corresponding parameters of the trained neural task network is evaluated by means of a predetermined cost function. Parameters that characterize the behavior of the hypernetwork are optimized with the aim of improving the evaluation by the cost function during further processing of retrieval vectors.

The hypernetwork trained in this way is specific to the selected division of the processing of the input data into multiple calculation steps, and therefore also to the selected hardware platform. With the training method proposed here, the processing of one and the same fully trained task network can thus be adapted to different hardware platforms.

The methods of the present invention can in particular be wholly or partially computer-implemented. The present invention therefore also relates to a computer program comprising machine-readable instructions that, when executed on one or more computers and/or compute instances, cause the computer(s) and/or compute instance(s) to perform one of the described methods. In this sense, control devices for vehicles and embedded systems for technical devices, which are also capable of executing machine-readable instructions, are also to be regarded as computers. Compute instances can, for example, be virtual machines, containers, or serverless execution environments, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for processing input data 2 by a neural task network 1, according to the present invention.

FIG. 2 is an illustration of the step-by-step processing of the input data 2 in multiple processing steps 4a-4c, according to an example embodiment of the present invention.

FIG. 3 shows an exemplary embodiment of the method 200 for training a hypernetwork 7, according to the present invention.

### DETAILED DESCRIPTION OF EXAMPLE EMBODIMENTS

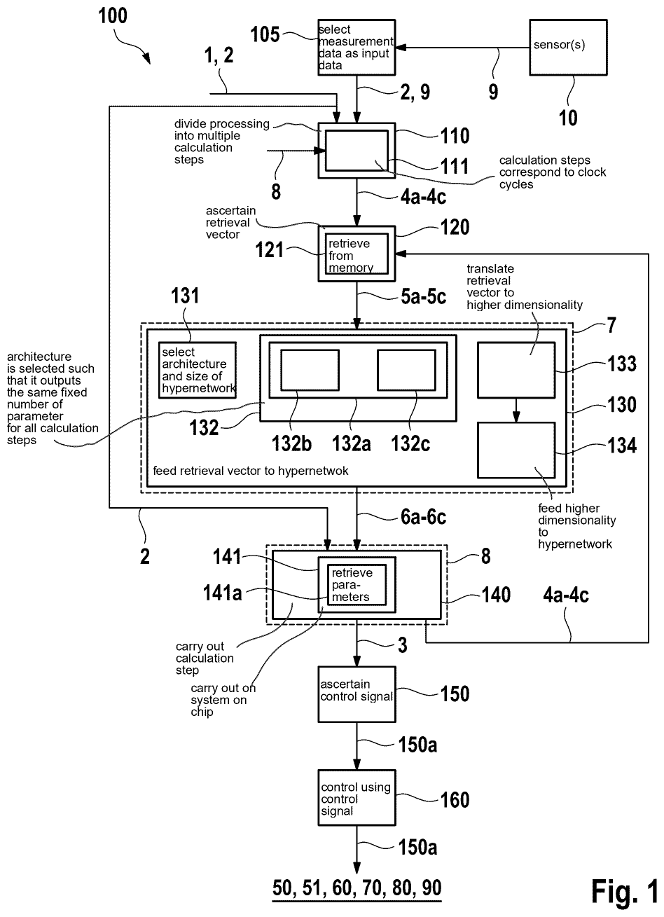

FIG. 1 is a schematic flowchart of an exemplary embodiment of the method 100 for processing input data 2 by a neural task network 1, whose behavior is characterized by trainable parameters 6, to produce output data 3.

In particular, for example, according to block 105, measurement data 9 recorded by means of at least one sensor 10 can be selected as input data 2.

In step 110, the processing of the input data 2 by the neural task network 1 to produce output data 3 is divided into multiple calculation steps 4a-4c at least based on the architecture of the neural task network 1. During these calculation steps 4a-4c, different subsets 6a-6c of the trainable parameters 6 are required simultaneously.

In particular, for example, the multiple calculation steps 4a-4c can correspond to clock cycles of a hardware platform 8 used for the calculation. (Step 111).

In step 120, for each of the calculation steps 4a-4c, a retrieval vector 5a-5c for accessing the respective, simultaneously required trainable parameters 6a-6c is ascertained.

According to block 121, the retrieval vectors 5a-5c for each calculation step 4a-4c can be retrieved from a memory.

In step 130, the retrieval vector 5a-5c is fed to a hypernetwork 7, which then outputs the parameters 6a-6c required simultaneously for the calculation step 4a-4c.

According to block 131, the architecture and size of the hypernetwork 7 can be selected such that the behavior of the hypernetwork 7 is characterized by a number of parameters that corresponds at most to a predetermined fraction of the number of parameters that characterize the behavior of the neural task network 1. This fraction can, for example, be at most 1/500, preferably at most 1/800, and most preferably at most 1/1000.

According to block 132, the architecture of the hypernetwork 7 can be selected such that it outputs the same fixed number of parameters 6a-6c for all calculation steps 4a-4c.

In particular, for example, according to block 132a, a fixed number of parameters 6a-6c can be selected that
is less than the largest number of parameters 6a-6c required simultaneously for a calculation step 4a-4c and
is greater than the smallest number of parameters 6a-6c required simultaneously for a calculation step 4a-4c.

In particular, for example,
according to block 132b, in response to the hypernetwork 7 not having provided all the parameters 6a-6c required simultaneously for a calculation step 4a-4c, the missing required parameters 4a-4c can be set to standard values, and/or
according to block 132c, in response to the hypernetwork 7 having provided more than the parameters 6a-6c required simultaneously for a calculation step 4a-4c, the excess provided parameters 4a-4c can be discarded.

According to block 133, the retrieval vector 5a-5c can be translated to a higher dimensionality by means of a predetermined coding function. According to block 134, said retrieval vector can then be fed in this higher dimensionality to the hypernetwork 7.

In step 140, the particular calculation step 4a-4c is carried out on the hardware platform 8 using the parameters 6a-6c obtained from the hypernetwork 7. For the remaining calculation steps 4a-4c, the ascertainment of retrieval vectors 5a-5c, the retrieval of parameters 6a-6c from the hypernetwork 7, and the execution 140 of these steps 4a-4c are then repeated until the final output 3 of the neural task network 1 is finally created.

In particular, for example, according to block 141, the calculation can be carried out on a system-on-chip, SoC, which combines all the functions of a computer in one integrated circuit. In particular, for example, according to block 141a, at least the parameters 7a that characterize the behavior of the hypernetwork 7 can then be retrieved from a memory within the SoC.

In the example shown in FIG. 1, in step 150, a control signal 150a is ascertained from the calculated output data 3, which can in particular be based on measurement data 9 as input data 2, for example. Then, in step 160, a vehicle 50, a driver assistance system 51, a robot 60, a system 70 for quality control, a system 80 for monitoring areas, and/or a system 90 for medical imaging is controlled with the control signal 150a.

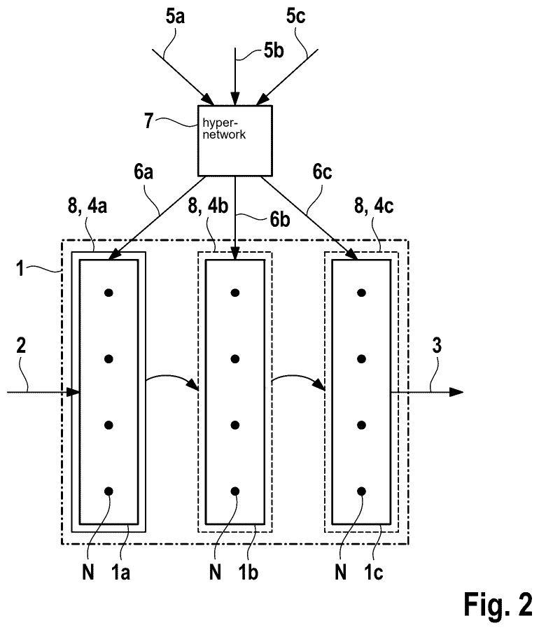

The step-by-step processing of the neural task network 1, and thus the path from the input data 2 to the output data 3, is illustrated in more detail in FIG. 2.

In the example shown in FIG. 2, the neural task network 1 is divided into layers 1a, 1b, and 1c having neurons N, and the processing of these layers also corresponds to the processing steps 4a, 4b, and 4c, respectively.

Thus, the hardware platform 8 is initially used to process the first layer 1a. For this purpose, the first retrieval vector 5a is fed to the hypernetwork 7, whereupon the hypernetwork 7 outputs the parameters 6a for the first layer 1a.

The second retrieval vector 5b is then fed to the hypernetwork 7, whereupon the hypernetwork 7 outputs the parameters 6b for the second layer 1b. The output of the first layer 1a is then fed to the second layer 1b, and the second layer 1b is processed by the hardware platform 8.

Finally, the third retrieval vector 5c is fed to the hypernetwork 7, whereupon the hypernetwork 7 outputs the parameters 6c for the third layer 1c. The output of the second layer 1b is then fed to the third layer 1c, and the third layer 1c is processed by the hardware platform 8. This results in the final output data 3, which are based on the original input data 2.

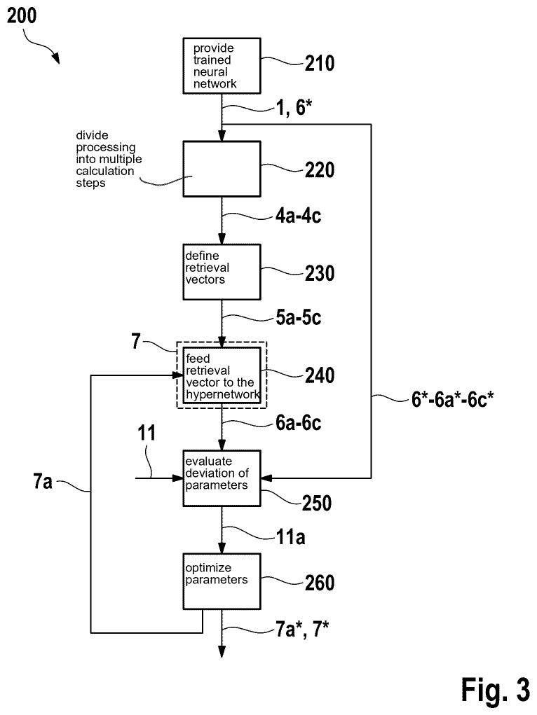

FIG. 3 is a schematic flowchart of an exemplary embodiment of the method 200 for training a hypernetwork 7 for use in the above-described method 100.

In step 210, a trained neural task network 1 is provided for processing input data to produce output data 3. The behavior of this task network 1 is characterized by trainable parameters 6*.

In step 220, the processing of the input data 2 by the neural task network 1 to produce output data 3 is divided into multiple calculation steps 4a-4c at least based on the architecture of the neural task network 1. During the execution of these calculation steps 4a-4c, different subsets 6a-6c of the trainable parameters 6 are required simultaneously.

In step 230, a retrieval vector 5a-5c is defined for each calculation step 4a-4c. This retrieval vector 5a-5c specifies the position of the respective, simultaneously required trainable parameters 6a-6c in the architecture of the neural network 1.

In step 240, the retrieval vector 5a-5c is fed to the hypernetwork 7 to be trained. The hypernetwork 7 then outputs the parameters 6a-6c required simultaneously for the calculation step 4a-4c.

In step 250, the deviation of the parameters 6a-6c provided by the hypernetwork 7 from the corresponding parameters 6a*-6c* of the trained neural task network 1 is evaluated by means of a predetermined cost function 11. An evaluation 11a is created.

In step 260, parameters 7a characterizing the behavior of the hypernetwork 7 are optimized with the aim of improving the evaluation 11a by the cost function 11 during further processing of retrieval vectors 5a-5c. The fully optimized state of the parameters 7a is denoted by reference sign 7a* and defines the trained state 7* of the hypernetwork 7.

1-15. (canceled)

16. A method for processing input data by a neural task network, whose behavior is characterized by trainable parameters, to produce output data, comprising the following steps:
dividing the processing of the input data by the neural task network to produce the output data into multiple calculation steps at least based on an architecture of the neural task network, wherein in the calculation steps, different respective subsets of the trainable parameters are required simultaneously;
for each respective calculation step of the calculation steps, ascertaining a respective retrieval vector for accessing the respective subset of the trainable parameters required simultaneously by the respective calculation step;
feeding each respective retrieval vector to a hypernetwork, which then outputs the respective subset of the trainable parameters required simultaneously for the respective calculation step; and
carrying out each calculation step with the respective subset of trainable parameters.

17. The method according to claim 16, wherein the retrieval vectors for the calculation steps are retrieved from a memory.

18. The method according to claim 16, wherein the multiple calculation steps correspond to clock cycles of a hardware platform used for the calculations.

19. The method according to claim 16, wherein the architecture and size of the hypernetwork are selected such that a behavior of the hypernetwork is characterized by a number of parameters that corresponds at most to a predetermined fraction of the number of parameters that characterize the behavior of the neural task network.

20. The method according to claim 16, wherein the architecture of the hypernetwork is selected such that the hypernetwork outputs the same fixed number of parameters for all calculation steps.

21. The method according to claim 20, wherein a fixed number of parameters is selected that the fixed number:
is less than a largest number of parameters required simultaneously for a calculation step, and
is greater than a smallest number of parameters required simultaneously for a calculation step.

22. The method according to claim 21, wherein:
in response to the hypernetwork not having provided all the parameters required simultaneously for a calculation step, missing required parameters are set to standard values, and/or
in response to the hypernetwork having provided more than the parameters required simultaneously for a calculation step, excess provided parameters are discarded.

23. The method according to claim 16, wherein each respective retrieval vector is translated to a higher dimensionality using a predetermined coding function and is fed in the higher dimensionality to the hypernetwork.

24. The method according to claim 16, wherein each calculation step is carried out on a system-on-chip (SoC) which combines all functions of a computer in one integrated circuit.

25. The method according to claim 24, wherein at least parameters characterizing the behavior of the hypernetwork are retrieved from a memory within the SoC.

26. The method according to claim 16, wherein:
measurement data recorded using at least one sensor are selected as input data;
a control signal is ascertained from the output data; and
a vehicle and/or a driver assistance system and/or a robot and/or a system for quality control and/or a system for monitoring areas and/or a system for medical imaging, is controlled with the control signal.

27. A method for training a hypernetwork, comprising the following steps:
providing a trained neural task network for processing input data to produce output data, a behavior of the trained neural task network being characterized by trainable parameters;
dividing processing of the input data by the neural task network to produce the output data into multiple calculation steps at least based on an architecture of the neural task network, each of the calculation steps requiring different respective subsets of the trainable parameters simultaneously;
defining, for each calculation step, a respective retrieval vector that specifies a position of the simultaneously required respective subset of the trainable parameters in the architecture of the neural network;
feeding the respective retrieval vector to the hypernetwork to be trained, which then outputs the simultaneously required respective subset of the trainable parameters for each calculation step;
evaluating a deviation of parameters provided by the hypernetwork from corresponding parameters of the trained neural task network using a predetermined cost function; and
optimizing the parameters characterizing the behavior of the hypernetwork, with an aim of improving the evaluation by the cost function during further processing of the retrieval vectors.

28. A non-transitory machine-readable data carrier on which is stored a computer program including machine-readable instructions for processing input data by a neural task network, whose behavior is characterized by trainable parameters, to produce output data, the instructions, when executed by one or more computers and/or computer instances, causing the one or more computers and/or computer instances to perform the following steps:
dividing the processing of the input data by the neural task network to produce the output data into multiple calculation steps at least based on an architecture of the neural task network, wherein in the calculation steps, different respective subsets of the trainable parameters are required simultaneously;
for each respective calculation step of the calculation steps, ascertaining a respective retrieval vector for accessing the respective subset of the trainable parameters required simultaneously by the respective calculation step;
feeding each respective retrieval vector to a hypernetwork, which then outputs the respective subset of the trainable parameters required simultaneously for the respective calculation step; and
carrying out each calculation step with the respective subset of trainable parameters.

29. One or more computers and/or compute instances comprising a non-transitory machine-readable data carrier on which is stored a computer program including machine-readable instructions for processing input data by a neural task network, whose behavior is characterized by trainable parameters, to produce output data, the instructions, when executed by the one or more computers and/or computer instances, causing the one or more computers and/or computer instances to perform the following steps:
dividing the processing of the input data by the neural task network to produce the output data into multiple calculation steps at least based on an architecture of the neural task network, wherein in the calculation steps, different respective subsets of the trainable parameters are required simultaneously;
for each respective calculation step of the calculation steps, ascertaining a respective retrieval vector for accessing the respective subset of the trainable parameters required simultaneously by the respective calculation step;
feeding each respective retrieval vector to a hypernetwork, which then outputs the respective subset of the trainable parameters required simultaneously for the respective calculation step; and
carrying out each calculation step with the respective subset of trainable parameters.
